(19) United States
(12) Patent Application Publication
(10) Pub. No.: US 2018/0045243 A1
(43) Pub. Date: Feb. 15, 2018

(54) ENCAPSULATED AXIAL BEARING ASSEMBLY HAVING AN INTERNAL DAMPING LAYER

(71) Applicant: Schaeffler Technologies AG & Co. KG, Herzogenaurach (DE)

(72) Inventors: Joseph T. Griffin, Matthews, NC (US); James Kevin Brown, Rock Hill, SC (US); Eric S. Nelson, Charlotte, NC (US)

(73) Assignee: Schaeffler Technologies AG & Co. KG, Herzogenaurach (DE)

(21) Appl. No.: 15/232,776

(22) Filed: Aug. 9, 2016

(51) Int. Cl. F16C 19/52; F16C 33/58; F16C 19/30

(52) U.S. Cl. CPC F16C 19/527; F16C 19/30; F16C 33/583; F16C 2326/06; F16C 2326/05

(57) ABSTRACT

An axial roller bearing assembly is provided. The axial roller bearing assembly has a first axial washer including a first race surface and a second axial washer including a thrust surface. The first axial washer and the second axial washer form a housing space. The axial roller bearing assembly also has a third axial washer disposed in the housing space between the first axial washer and the second axial washer and including a second race surface. A bearing element also disposed in the housing space has a cage and a plurality of rollers in contact with the first race surface and the second race surface. A damping layer is also disposed in the housing space and is in contact with the second axial washer and the third axial washer. The damping layer inhibits vibration from transferring between the third axial washer and the second axial washer.

### FIELD OF INVENTION

The present invention relates to an encapsulated bearing assembly, and, more particularly, to an encapsulated bearing assembly having an internal damping layer.

### BACKGROUND

Axial roller bearings are used in various applications, including automotive assemblies such as drivetrain and suspension components, to distribute loads and allow for relative rotation. These include thrust bearings, which are positioned adjacent to a component in order to carry an axial load exerted by that component. Thrust and other axial roller bearings are often encapsulated in that they include a plurality of rollers enclosed by an opposing pair of washers. The rollers are positioned in a cage and directly contact races formed by inner surfaces of the washers. While this is a typical bearing configuration, it may be less than ideal in certain situations because the direct contact between all components allows the bearing to transmit vibration from one side to the other, and to adjacent components, fairly easily. For example, a typical thrust bearing may transmit vibration to a transmission case, which may then lead to undesirable noise being produced from the case.

Excessive vibration can be inhibited by preventing surface defects in the rollers and races of the bearings. However, ensuring that all components are made without even minor defects is cost prohibitive and generally not feasible. Another potential solution is to include an external damping layer between the bearing and the adjacent component, such as in the configuration described in U.S. Patent Application No. 2011/0182542. A drawback of the external damping layer, however, is that it may wear due to rotation of the bearing relative to the adjacent component.

It would therefore be desirable to provide an axial roller bearing which addresses the problem of edge loading and other drawbacks of the prior art.

### SUMMARY

In one aspect, the present disclosure is directed to an axial roller bearing assembly. The axial roller bearing assembly includes a first axial washer including a first race surface and a second axial washer including a thrust surface. The first axial washer and the second axial washer form a housing space. The axial roller bearing assembly also includes a third axial washer disposed in the housing space between the first axial washer and the second axial washer and including a second race surface. The axial roller bearing assembly further includes a bearing element disposed in the housing space and which includes a cage and a plurality of rollers in contact with the first race surface and the second race surface. The axial roller bearing assembly also includes a damping layer disposed in the housing space and in contact with the second axial washer and the third axial washer. The damping layer inhibits vibration from transferring between the third axial washer and the second axial washer.

### BRIEF DESCRIPTION OF THE DRAWING(S)

The foregoing Summary and the following detailed description will be better understood when read in conjunction with the appended drawings, which illustrate a preferred embodiment of the invention. In the drawings:

FIG. 1 is a cross-sectional view of an axial roller bearing including an internal damping layer.

### DETAILED DESCRIPTION OF THE PREFERRED EMBODIMENT(S)

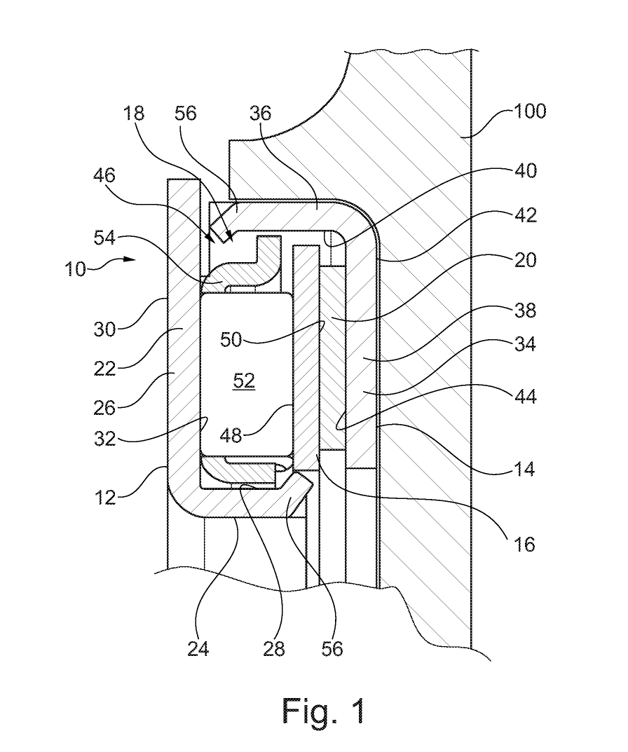

FIG. 1 depicts an axial roller bearing assembly 10. In an exemplary embodiment, the axial roller bearing assembly 10 is positioned adjacent to a part of a transmission case 100 and used as a thrust bearing. It should be understood, however, that the axial roller bearing assembly 10 may be used in other environments, such as adjacent to other components that are particularly susceptible to generating excessive noise when vibrated. The axial roller bearing assembly 10 (“bearing assembly 10”) includes a first axial washer 12, a second axial washer 14, a third axial washer 16, a bearing element 18, and a damping layer 20.

The first axial washer 12 includes a circumferentially extending body 22 which includes an axial flange 24 and a radial flange 26. The axial flange 24 extends axially and forms an enclosing surface 28. The radial flange 26 is directly connected to and extends in an outward-radial direction from the axial flange 24. The radial flange 26 defines an outer thrust surface 30 and an inner race surface 32 (i.e. a first race surface). In an exemplary embodiment, the axial flange 24 and radial flange 26 form an L-shaped cross-section, with the axial flange 24 extending in a first axial direction (e.g., toward the transmission case 100) at a radially-inner section of the bearing assembly 10.

The second axial washer 14 includes a second circumferentially extending body 34 which includes an axial flange 36 and a radial flange 38. The axial flange 36 extends axially and forms an enclosing surface 40. The radial flange 38 is directly connected to and extends in an inward radial direction from the axial flange 36. The radial flange 38 defines an outer thrust surface 42 which, in an exemplary embodiment, is in contact with the transmission case 100. The radial flange also includes an inner surface 44. In an exemplary embodiment, the axial flange 36 and the radial flange 38 form an L-shaped cross-section, with the axial flange 36 extending in a second axial direction, which is opposite to the first axial direction (e.g., away from the transmission case 100) at a radially-outer section of the bearing assembly 10.

As shown in FIG. 1, the first axial washer 12 and the second axial washer 14 are positioned to form a housing space 46 for receiving the third axial washer 16, the bearing element 18, and the damping layer 20. For example, the L-shaped first and second washers 12, 14 are positioned such that the housing space 46 is formed axially between the inner race surface 32 and the inner surface 44, and radially between the enclosing surface 28 and the enclosing surface 40.

The third axial washer 16 is positioned in the housing space 46, between the bearing element 18 and the damping layer 20, and includes a race surface 48 (i.e., a second race surface) and a damping surface 50.

The bearing element 18 is preferably an axial needle roller arrangement, although other types of bearing elements are possible. In an exemplary embodiment, the bearing element 18 includes a plurality of rollers 52 which are spaced apart circumferentially from one another by a cage 54. The rollers 52 and cage 54 may be preassembled as a cage and roller assembly that includes the rollers 52 located in pockets in the cage 54, which is preferably stamped from sheet metal. The rollers 52 are located in at least some of the pockets and roll against the inner race surface 32 of the first axial washer 12 on one side and the race surface 48 of the third axial washer 16 on the opposite side. A lubricant may be positioned in between the race surfaces 32, 48 and the rollers 52. An axial force exerted on the bearing assembly 10 may help to maintain the rollers 52 in contact with the race surfaces 32, 48, which may help to ensure proper operation of the bearing assembly 10.

In order to connect the components of the bearing assembly 10, the first axial washer 12 and the second axial washer 14 preferably include interlocking features. For example, the first axial washer 12 and the second axial washer may include punch-in tabs 56 which overlap and/or are inserted into opposing portions of the cage 54. This interlocking connection retains the bearing element 18 within the first axial washer 12 and the second axial washer 14. Alternative means for interconnecting the components include external fasteners, an overlap of interlocking features on the axial washers themselves etc.

The damping layer 20 is positioned between and in contact with the inner surface 44 and the damping surface 50. The damping layer 20 is made of a vibration-reducing material which isolates the bearing element 18 from the second axial washer 14 and the transmission case 100. For example, the damping layer 20 may be formed from a polymer material having good sound and vibration damping qualities. Examples of materials that may be used for damping layer 20 include nitrile butadiene rubber (NRB), fluoroelastomers which contain vinylidene fluoride monomers, and acrylic. The damping layer 20 may include a hardness of approximately 50-75 durometer. In some embodiments, the damping layer 20 may include a thin steel core coated with a damping material, such as one of the materials listed above.

In an exemplary embodiment, the damping layer 20 is formed to be a flat ring-shaped component. For example, the damping layer 20 may include an axial thickness that is much less than a radial length (i.e., the radial dimension of the cross-section of the damping layer 20 shown in FIG. 1). In this way, the damping layer 20 does not dramatically increase an overall thickness of the axial roller bearing assembly 10. This can be further addressed by forming associated thicknesses of the first, second, and third axial washers 12, 14, 16 to be smaller than a typical axial roller bearing assembly, and, in some embodiments, smaller than the thickness of the damping layer 20.

Moreover, the damping layer 20 is formed to be in surface contact with the second and third axial washers 14, 16. For example, the opposing surfaces of the damping layer 20 may be in surface contact with the inner surface 44 and the damping surface 50. In some embodiments, in order to sufficiently decouple the second and third axial washers 14, 16, the damping layer 20 may contact at least 80% of a surface area of the inner surface 44 and the damping surface 50.

In use, the damping layer 20 inhibits the transfer of vibration from the third axial washer 16 to the second axial washer 14 and the adjacent transmission case 100 (and vice versa). In this way any vibration produced by the bearing element 16 (or another component in contact with the first axial washer 12) will be inhibited from causing the transmission case 100 to vibrate, thereby reducing the potential for the transmission case 100 to produce excessive noise and/or be damaged. Similarly, any vibration originating in the transmission case 100 (or other component in contact with the thrust surface 30) will not transfer through the bearing assembly 10.

Further, the interlocking connection with the cage 54 insures that the first and second axial washers 12, 14 remain decoupled from each other in terms of vibration-transmission. Vibration that occurs due to the rollers 52 will primarily be localized to the first and third axial washer 12, 16, and does not transfer easily through the cage 54. Therefore, despite the close positioning and interconnection of an encapsulated bearing, the disclosed configuration nevertheless allows such a bearing to inhibit the transfer of vibration from one side to another. In this way, such encapsulated bearings may be used in conjunction with components (i.e., transmission case 100) that are susceptible to vibration and/or on which vibration has a negative effect.

Having thus described various embodiments of the present bearing assembly 10 in detail, it is to be appreciated and will be apparent to those skilled in the art that many physical changes, only a few of which are exemplified in the detailed description above, could be made in the assembly without altering the inventive concepts and principles embodied therein. For example, in some embodiments, the components may be reversed, with the third axial washer 16 and the damping layer 20 positioned on an axially-outer side of the bearing element 18 and the second axial washer 14 defining a race surface in contact with the rollers 52. Moreover, the axial flanges 24, 36 may be reversed, with the axial flange 24 forming a radial-outer support surface and the axial flange 36 forming a radial-inner support surface.

The present embodiments are therefore to be considered in all respects as illustrative and not restrictive, the scope of the invention being indicated by the appended claims rather than by the foregoing description, and all changes which come within the meaning and range of equivalency of the claims are therefore to be embraced therein.

### PARTS LIST

10. Axial Roller Bearing Assembly
12. First Axial Washer
14. Second Axial Washer
16. Third Axial Washer
18. Bearing Element
20. Damping Layer
22. Body
24. Axial Flange
26. Radial Flange
28. Enclosing Surface
30. Thrust Surface
32. Race Surface
34. Body
36. Axial Flange
38. Radial Flange
40. Enclosing Surface
42. Thrust Surface
44. Inner Surface
46. Housing Space
48. Race Surface
50. Damping Surface
52. Roller
54. Cage
56. Punch-in Tab
100. Transmission Case

1. An axial roller bearing assembly, comprising:
a first axial washer including a first race surface;
a second axial washer including a thrust surface, the first axial washer and the second axial washer forming a housing space;
a third axial washer disposed in the housing space between the first axial washer and the second axial washer and including a second race surface;
a bearing element disposed in the housing space and including a cage and a plurality of rollers in contact with the first race surface and the second race surface; and
a damping layer disposed in the housing space and in contact with the second axial washer and the third axial washer,
wherein the damping layer inhibits vibration from transferring between the third axial washer and the second axial washer, and
wherein the second axial washer includes tabs which directly connect to the cage.

2. (canceled)

3. The axial roller bearing assembly of claim 1, wherein the first axial washer and the second axial washer are L-shaped and each include an axial flange and a radial flange.

4. The axial roller bearing assembly of claim 3, wherein the radial flange of the second axial washer includes an inner surface in surface contact with the damping layer and the third axial washer includes a damping surface in surface contact with the damping layer.

5. The axial roller bearing assembly of claim 4, wherein the damping layer contacts at least 80% of a surface area of the inner surface and the damping surface.

6. The axial roller bearing assembly of claim 3, wherein a thickness of the radial flanges and the third axial washer are each less than a thickness of the damping layer.

7. The axial roller bearing assembly of claim 1, wherein the damping layer is formed from a polymer material.

8. The axial roller bearing assembly of claim 1, wherein the thrust surface is in contact with portion of a transmission case.

9. (canceled)
